(19) United States
(12) Patent Application Publication
(10) Pub. No.: US 2024/0000010 A1
(43) Pub. Date: Jan. 4, 2024

(54) Combine Automation Regime-based Control

(71) Applicant: AGCO International GmbH, Neuhausen (CH)

(72) Inventor: Dan Hermann, Randers (DK)

(21) Appl. No.: 18/254,195

(22) PCT Filed: Nov. 30, 2021
(86) PCT No.: PCT/IB2021/061141

§ 371 Date: May 24, 2023

(30) Foreign Application Priority Data
Dec. 22, 2020 (GB) 2020322.0

(51) Int. Cl. A01D 41/127; A01D 41/14

(52) U.S. Cl. CPC A01D 41/127; A01D 41/141

(57) ABSTRACT

The present invention relates to a control system and method for controlling operation of one or more operational parameters of an agricultural machine. Using a position of the agricultural machine within a mapped environment; a heading parameter indicative of a direction of travel of the agricultural machine within the mapped environment is determined. An associated operational profile is then employed controlling operation of one or more operable components of the agricultural machine in dependence on the direction of travel of the machine within the mapped environment such that configuration of those components is appropriate for the environmental conditions.

### TECHNICAL FIELD

The present invention relates, in general, to agriculture technology, and in particular to at least part-automation of agricultural machine operation.

### BACKGROUND

Agricultural machines, such as combine harvesters, typically operate by travelling back and forth along parallel rows in a field. Variation in environmental conditions, e.g. slope, wind direction, crop moisture content, crop composition, crop distribution, etc. are experienced dependent on the direction of travel of the machine and in some instances during the transition therebetween—i.e. when turning at the end of a row (“headland”). Known systems are typically reactive and rely on an operator manually adjusting operating parameters of the machine based on observations, or utilise sensors to automate some of the parameter adjustments, e.g. by monitoring wind speed or slope and automating an appropriate adjustment in the operational settings based thereon.

It would be advantageous to provide an improved means to account for the variation in appropriate operational settings of an agricultural machine.

### SUMMARY OF THE INVENTION

In an aspect of the invention there is provided a control system for controlling operation of one or more operational parameters of an agricultural machine, the control system comprising one or more controllers, and being configured to:
receive positional data indicative of a position of the agricultural machine within a mapped environment;
determine a heading parameter indicative of a direction of travel of the agricultural machine within the mapped environment in dependence on the positional data;
retrieve an appropriate operational profile associated with the determined heading parameter, the operational profile comprising a set of one or more operational parameters for one or more operable components of or controllable by the agricultural machine; and
generate and output one or more control signals for controlling operation of the one or more operable components in accordance with the retrieved operational profile.

Advantageously, the control system is operable to retrieve and implement appropriate adjustments to operational parameters of the machine in dependence on a direction of travel of the machine within the mapped environment. Such a control system is less data intensive when compared with systems which monitor operational conditions in real time. The control system further provides a proactive approach to automating operation of the machine which may result in improved efficiency and yield of the corresponding harvesting process.

The operational parameter(s) of a given operational profile may be pre-defined. The operational parameter(s) may relate to parameter(s) utilised by the agricultural machine whilst traversing a path substantially parallel to the determined heading parameter. In this way, the control system may be operable to retrieve appropriate operational parameter(s) for the machine whenever the machine is determined to be travelling along substantially the same heading, as might be expected periodically during a harvesting operation wherein the machine is moved back and forth along substantially parallel rows in a field.

The control system may be operable to retrieve a first operational profile associated with a heading parameter indicative of a first direction of travel, and a second operational profile associated with a heading parameter indicative of a second direction of travel, wherein the first and second directions of travel are substantially parallel but opposite to one another.

The control system may be operable to receive additional sensor data. In such embodiments, the control system may be operable to update or adjust one or more operational parameters of an associated operational profile in dependence on the additional sensor data. The additional sensor data may relate to a wind direction, or slope data, for example. The additional sensor data may relate to a moisture content of a harvested material. The additional sensor data may relate to an identified crop content or characteristics, e.g. the presence, absence or proportion of useful/non-useful crop harvested during the harvesting process. The additional sensor data may relate to an orientation of crop material, e.g. relative to the ground, presence of down-lying crop, etc. The additional sensor data may relate to an operational speed of the agricultural machine. In this way, the control system of the present invention may incorporate a reactive response to currently experienced conditions to optimise or at least further improve on the operation of the agricultural machine.

The additional sensor data may be received from an optical sensor, such as an imaging device, e.g. a camera, LIDAR unit, infrared sensor or the like. The additional sensor data may be received from a moisture sensor. The additional sensor data may be received from an accelerometer, an inertial measurement unit (IMU), etc.

The control system may be operable to receive an operator adjustment of one or more operational parameters of a given operational profile. In this way, the control system may be able to account for an operator request to change the operation of the machine, for example to account for variations in the operating conditions not identified by the machine automatically.

The adjusted or updated operational parameter(s)—performed automatically using sensor data and/or in response to an operator adjustment—may be stored as part of the relevant operational profile for subsequent retrieval and implementation.

The one or more operable components preferably comprise components of an implement, e.g. a header, operably coupled to the agricultural machine, e.g. a harvester. For example, the one or more operable components may comprise one or more crop gathering mechanisms of the header, which may include a reel, draper belt, auger and/or cutter bar.

The one or more operational parameters may relate to an angle, e.g. pitch, tilt, yaw of the associated component. For instance, the control system may be operable to adjust a pitch of a header coupled to an agricultural machine in the form of a harvester. The tilt of the component(s) may be controlled to account for a slope of the environment.

The one or more operational parameters may relate to an operational speed of the one or more components, which may be a rotational speed, e.g. where the operable component comprises a reel of a crop gathering mechanism of a header. The one or more operational parameters may relate to a position (e.g. forward, backwards) or height of the associated component.

The control system may be operable to identify a turning action indicative of the machine being positioned at an end of a row/at a headland within the mapped environment. The turning action may be identified in dependence on positional data, or in some embodiments through data indicative of a turning angle of a steering mechanism of the agricultural machine. The control system may be operable to retrieve and optionally employ a third operational profile corresponding to one or more operational parameter(s) suitable for said turning action. This may include raising the height of an attached implement, or stopping movement (e.g. rotation) of one or more components of the machine or implement, for example.

The control system may be operable to identify areas within the mapped environment having potentially poor harvesting/crop characteristics, for example, using map data (e.g. stored locations of areas/regions with poor crop characteristics) or additional sensor data. Poor crop characteristics may be identified based on a moisture content of the crop, presence of weed material within the crop, and/or the position of orientation of the crop—e.g. down-lying crop. Using the positional data, the control system may be operable to identify when the agricultural machine is at, is proximal to, is currently traversing, or is about to traverse such an area, and retrieve and optionally employ a fourth operational profile. The fourth operational profile may comprise operational parameter(s) suitable for such a region, which may include raising the height of an attached implement, or stopping movement (e.g. rotation) of one or more components of the machine or implement, for example, to halt a crop gathering process at that location.

The control system may be operable to control operation of a user interface on, within or otherwise associated with the agricultural machine for outputting an indication to an operator of the machine indicative of the current operational profile under which the machine is operating. The user interface may be a display or audio device, for example.

The control system may be operable to receive the positional data form a positioning system, which may be a satellite-based positioning systems such as GPS, GLONASS, Galileo and the like. In embodiments, the positioning system may be a Real Time Kinematic (RTK) satellite navigation system. In such embodiments, the control system may be communicable with one or more base stations located within or proximal to the mapped environment, and may be configured to retrieve or itself determine positional data for the agricultural machine using the RTK system, e.g. using data received from position module(s) associated with the machine and the one or more base stations.

The control system may be operable to retrieve an appropriate operational profile in dependence on the position of the machine within the mapped environment.

The one or more controllers may collectively comprise an input (e.g. an electronic input) for receiving one or more input signals indicative of the positional data. The one or more controllers may collectively comprise one or more processors (e.g. electronic processors) operable to execute computer readable instructions for controlling operation of the control system, for example to determine the heading parameter and/or retrieve the operational profile. The one or more processors may be operable to generate one or more control signals for controlling operation of the one or more operable components. The one or more controllers may collectively comprise an output (e.g. an electronic output) for outputting the one or more control signals.

In an aspect of the invention there is provided a control system for controlling operation of one or more operational parameters of an agricultural machine, the control system comprising one or more controllers, and being configured to:
receive positional data indicative of a position of the agricultural machine within a mapped environment;
determine the position of the agricultural machine within the mapped environment in dependence on the positional data;
retrieve an appropriate operational profile associated with the determined position, the operational profile comprising a set of one or more operational parameters for one or more operable components of or controllable by the agricultural machine; and
generate and output one or more control signals for controlling operation of the one or more operable components in accordance with the retrieved operational profile.

The control system may be operable to identify areas within the mapped environment having particular (e.g. poor) harvesting/crop characteristics, for example, using map data (e.g. stored locations of areas/regions with such crop characteristics) or additional sensor data. Crop characteristics may include a moisture content of the crop, presence or absence of weed material within the crop, and/or the position of orientation of the crop—e.g. standing vs. down-lying crop. Using the positional data, the control system may be operable to identify when the agricultural machine is at, is proximal to, is currently traversing, or is about to traverse such an area, and retrieve and optionally employ an appropriate operational profile. The retrieved operational profile may comprise operational parameter(s) suitable for such a region, which may include raising the height of an attached implement, or stopping movement (e.g. rotation) of one or more components of the machine or implement, for example, to halt a crop gathering process at that location where said location corresponds to an area of the mapped environment determined to have poor crop characteristics.

According to an aspect of the invention there is provided a system for controlling operation of one or more operational parameters of an agricultural machine, the system comprising a control system as described herein; and a positioning module configured to obtain positional data indicative of a position of the agricultural machine within the mapped environment.

The system optionally comprises one or more operable components of the machine.

A further aspect of the invention provides an agricultural machine comprising a control system or system as described herein. Optionally the agricultural machine comprises a harvesting machine, e.g. a combine harvester.

In a further aspect of the invention there is provided a method for controlling operation of one or more operational parameters of an agricultural machine, the method comprising:
determining a heading parameter indicative of a direction of travel of an agricultural machine within a mapped environment in dependence on positional data indicative of a position of the agricultural machine within the environment;
retrieving or identifying an appropriate operational profile associated with the determined heading parameter, the operational profile comprising a set of one or more operational parameters for one or more operable components of or controllable by the agricultural machine; and
controlling operation of the one or more operable components in accordance with the associated operational profile.

The method may comprise receiving positional data indicative of a position of the machine within the mapped environment, and determining the heading parameter in dependence thereon.

The method may comprise retrieving a first operational profile associated with a heading parameter indicative of a first direction of travel, and a second operational profile associated with a heading parameter indicative of a second direction of travel, wherein the first and second directions of travel are substantially parallel but opposite to one another.

The method may comprise receiving additional sensor data, and optionally updating or adjusting one or more operational parameters of an associated operational profile in dependence on the additional sensor data. The method may comprise receiving an operator adjustment of one or more operational parameters of a given operational profile. The adjusted or updated operational parameter(s)—performed automatically using sensor data and/or in response to an operator adjustment—may be stored as part of the relevant operational profile for subsequent retrieval and implementation.

The method may comprise identifying a turning action indicative of the machine being positioned at an end of a row/at a headland within the mapped environment. The turning action may be identified in dependence on positional data, or in some embodiments through data indicative of a turning angle of a steering mechanism of the agricultural machine. The method may comprise retrieving and optionally employing a third operational profile corresponding to one or more operational parameter(s) suitable for said turning action.

The method may comprise identifying areas within the mapped environment having potentially poor harvesting/crop characteristics, for example, using map data or additional sensor data. Poor crop characteristics may be identified based on a moisture content of the crop, presence of weed material within the crop, and/or the position of orientation of the crop—e.g. down-lying crop. Using the positional data, the may be possible to identify when the agricultural machine is at, is proximal to, is currently traversing, or is about to traverse such an area, and retrieve and optionally employ a fourth operational profile. The fourth operational profile may comprise operational parameter(s) suitable for such a region.

The method may comprise outputting an indication to an operator of the machine indicative of the current operational profile under which the machine is operating. The user interface may be a display or audio device, for example.

In an aspect of the invention there is provided a method for controlling operation of one or more operational parameters of an agricultural machine, the method comprising:
receiving positional data indicative of a position of the agricultural machine within a mapped environment;
determining the position of the agricultural machine within the mapped environment in dependence on the positional data;
retrieving an appropriate operational profile associated with the determined position, the operational profile comprising a set of one or more operational parameters for one or more operable components of or controllable by the agricultural machine; and
generating and output one or more control signals for controlling operation of the one or more operable components in accordance with the retrieved operational profile.

According to a further aspect of the invention there is provided computer software comprising computer readable instructions which, when executed by one or more processors, causes performance of a method as described herein.

Optionally, the software is stored on a non-transitory computer readable storage medium.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention will now be described, by way of example only, with reference to the accompanying drawings, in which:

FIG. 1 is a schematic side cross-sectional view of an agricultural harvester embodying aspects of the invention;

FIG. 2 is a schematic view of an embodiment of a control system of the invention; and

FIG. 3 is a flow chart illustrating an embodiment of a method of the invention.

### DETAILED DESCRIPTION

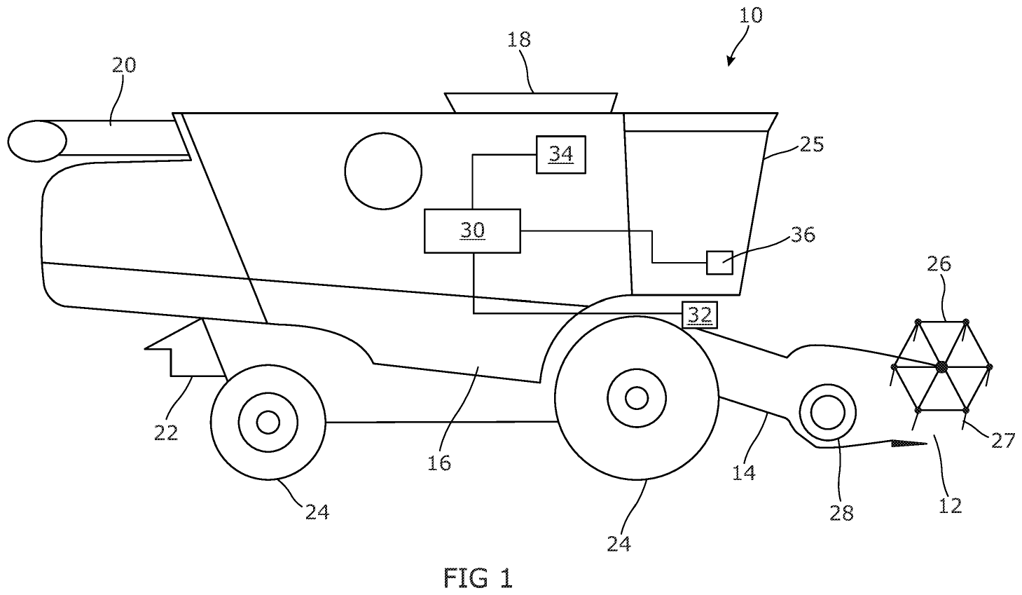

FIG. 1 illustrates an agricultural machine in the form of a combine harvester 10 embodying aspects of the present invention.

The harvester 10 is coupled to a header 12 which is operable, in use, to cut and gather a strip of crop material as the harvester 10 is driven across a field/area to be harvested during a harvesting operation. A conveyor section 14 conveys the cut crop material from the header 12 into a crop processing apparatus 16 operable to separate grain and non-grain (i.e. material other than grain (MOG)) as will be appreciated. It is noted here that apparatus for separating grain and non-grain material are well-known in the art and the present invention is not limited in this sense. The skilled person will appreciate that numerous different configurations for the crop processing apparatus may be used as appropriate. Clean grain separated from the cut crop material is collected in a grain bin 18, which may be periodically emptied, e.g. into a collection vehicle, storage container, etc. utilising unloading auger 20. The remaining non-grain material or MOG is separately moved to a spreader tool 22 which is operable in use to eject the non-grain material or MOG from the rear of the harvester 10 and onto the ground. It will be appreciated that in some embodiments the harvester 10 may also include a chopper tool positioned, for example, between the crop processing apparatus 16 and the spreader tool 22 and operable, in use, to cut the non-grain material or MOG before it is spread by the spreader tool 22.

The harvester 10 also typically includes, amongst other features, an operator cab 25, wheels 24, engine (not shown) and a user interface 36. As will be discussed in detail herein, the harvester 10 additionally includes a positioning module 34 operable, in use, to obtain information relating to the position of the harvester 10 within a mapped environment. Here, the positioning module 34 forms part of a satellite-based positioning system such as GPS, GLONASS, Galileo and the like. In an extension of the illustrated embodiment(s), the positioning system may be a Real Time Kinematic (RTK) satellite navigation system, with the positioning module 34 and/or control system 30 being communicable with one or more base stations located within or proximal to the mapped environment, and be configured to retrieve or itself determine positional data for the harvester 10 using the RTK system. Further, and again as described herein, the harvester 10 embodies a control system 30 operable to control operation of one or more components, e.g. components of the header 12 in dependence primarily on the position of the harvester 10 within the environment.

The header 12 comprises, amongst other components, a crop gathering mechanism which includes a reel 26 and auger 28, along with a cutter bar (not shown) disposed on a leading edge of the header 12. The reel 26 includes a plurality of guide bars 27, here six, which are mounted on (hexagonal) wheels which rotate around a transverse axis above the cutter bar. Auger 28 is provided transversely across the width of the header 12 and comprises a rotatable core supported for rotation by a support shaft. As will be appreciated, standing crop such as cereals or maize may be cut by the cutter bar as the harvester 10 advances in a forward direction across a crop field. The reel 26 rotates and guides the cut crop into the header 12, and specifically onto the auger 28. The auger 28 engages the cut crop material so as to convey the crop material inwardly towards the centre of the header 12 and specifically towards the conveyor section 14 for transferring the cut crop into the crop processing apparatus.

Header control unit 32 is provided for controlling operation of the components of the header 12 in accordance with control instructions provided by the control system 30 as described herein. The header components may typically be operated mechanically through one or more driveshafts (not shown) extending from the harvester 10. However, as an alternative to mechanically driving the components of the header 12, one or more of the components may be provided with electric drive through one or more electric motors mounted on the header 12 and driving the components directly, e.g. through transmission of control signals from the header control unit 32 and/or directly from the control system 30.

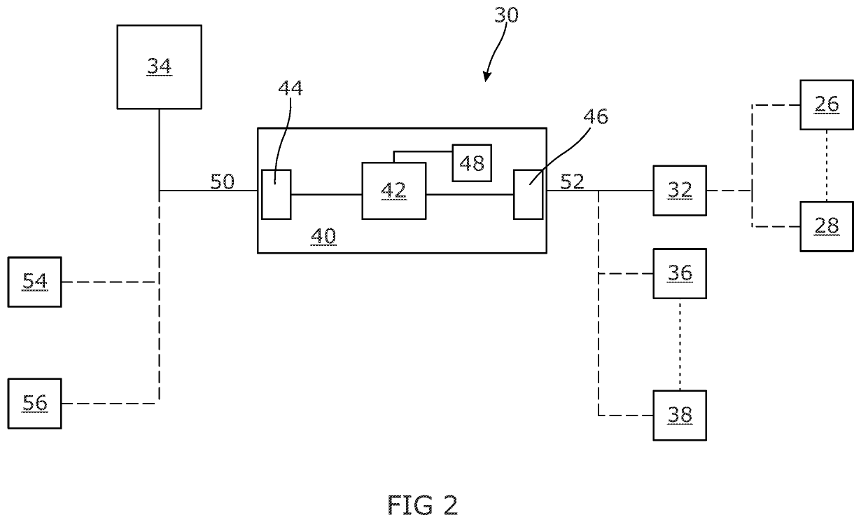

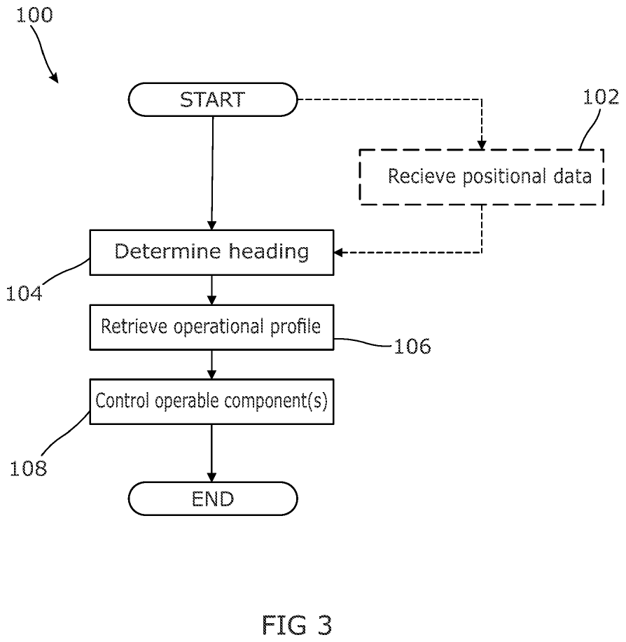

As detailed herein, the present invention relates to controlling operation of one or more operable components of the harvester 10, or controllable by the harvester 10—e.g. components of the header 12—in dependence on a position and specifically a direction of travel of the harvester 10 within a mapped environment. An embodiment of a method 100 of the invention is illustrated in FIG. 3, and is discussed herein with reference to FIGS. 1 to 3.

At step 104, a heading parameter indicative of a direction of travel of the harvester 10 within the mapped environment is determined in dependence on positional data (optionally received from a positioning module 34 associated with the harvester 10—step 102) indicative of a position of the harvester 10 within the environment. For instance, the position of the harvester 10 at two time points (e.g. a first location at time T1, and a second location at time T2) may be used to determine a direction of travel of the harvester from the first location to the second location (the heading parameter) with respect to a coordinate system of the mapped environment.

Utilising the determined direction of travel, the method 100 proceeds at step 106 by retrieving an appropriate operational profile associated with the determined heading parameter. The retrieved operational profile comprises a set of one or more operational parameters for one or more operable components of or controllable by the harvester 10. The operational parameter(s) of the retrieved operational profile are advantageously pre-defined and relate to parameter(s) utilised by the harvester 10 whilst traversing a path substantially parallel to the determined heading parameter. In this way, the present invention may automatically retrieve appropriate operational parameter(s) for the machine whenever the machine is determined to be travelling along substantially the same heading, as might be expected periodically during a harvesting operation wherein the harvester 10 is moved back and forth along substantially parallel rows in the mapped environment. The method 100 may advantageously switch between first and second operational profiles whilst performing such an operation.

Operation of the one or more operable components in then controlled, in step 108, based on the retrieved operational profile. In the illustrated embodiment this takes the form of outputting control signals 52 to the header control unit 32 for controlling operation of components e.g. reel 26, auger 28, etc. of the header 12. Here, this includes control over an angle, e.g. pitch, tilt, yaw, an operational speed, e.g. a rotational speed, and/or a positon or height of the relevant component, specifically of the reel 26 and/or auger 28, or the header 12 as a whole, e.g. to account for a slope associated with the determined heading, or an expected wind direction associated with the heading.

Further control actions may include controlling operation of one or more operable components of the harvester 10 itself. For instance, control signals 52 may be output to a harvester control unit 38 for controlling operational parameters of the harvester 10, including, for example, a forward speed of the harvester 10, and/or a steering direction of the harvester 10—e.g. to account for a slope in the environment to maintain the identified direction of travel. Further, control signals 52 may be output to the user interface 36 to control output of an indicator, e.g. a visual indicator, of the operational profile employed at any given time.

In an extension of the method 100, the positional data from positing module 34, and/or steering data, e.g. from harvester control unit 38 may be used to identify a turning action indicative of the harvester 10 being positioned at an end of a row/at a headland within the mapped environment. Here, a third operational profile corresponding to one or more operational parameter(s) suitable for said turning action may be retrieved and employed, which may include raising the height of the header 12, or stopping movement (e.g. rotation) of the reel 26 or auger 28, for example, to temporarily pause the harvesting operation during the turn.

In a further extension of the method 100, areas within the mapped environment may be identified as having potentially poor harvesting/crop characteristics, for example, using map data indicative of a location or locations within the environment with such characteristics or additional sensor data, e.g. from camera 56. Using the positional data, it may be possible to identify whether the harvester 10 is at, is proximal to, is currently traversing, or is about to traverse such an area, and retrieve and optionally employ a fourth operational profile. The fourth operational profile may comprise operational parameter(s) suitable for such a region, e.g. operational parameters corresponding to the pausing of the harvesting operation whilst at or traversing that particular location.

In a further variant the method 100 may include receiving additional sensor data, e.g. relating to a wind speed from a wind speed sensor 54, and/or visual data from an imaging sensor in the form of camera 56 mounted on the harvester 10, and/or an operator input for adjusting one or more of the operational parameters. The additional sensor data and/or the operator input can be used to supplement the method 100, and specifically to introduce a reactive component to the control over the operable components of the harvester 10 and/or header 12. This may allow for such factors to be considered and appropriate updates/adjustments made to the relevant operational profiles to account for variations in operational conditions, e.g. between consecutive passes of a field during a harvesting process.

FIG. 3 specifically is a schematic illustration of an embodiment of a control system 30 in accordance with the invention, and its functionality within a wider system for agricultural vehicles (e.g. harvester 10). As discussed in detail herein, the control system 30 is operable to control operation of one or more operable components 26, 28, 36, 38 of an agricultural implement (e.g. the header 12 of harvester 10) in dependence on a direction of travel of the harvester 10 within the mapped environment.

Here, the control system 30 comprises a controller 40 having an electronic processor 42, an electronic input 44, an electronic output 46 and memory 48. The processor 42 is operable to access the memory 48 and execute instructions stored therein to perform given functions, specifically to cause performance of the method 100 of FIG. 3 in the manner described hereinabove, ultimately generating and outputting control signals 52 from output 46 for controlling operation of the one or more operable components 26, 28, 36, 38 of the header 12 in dependence on positional data received from a positioning module 34 of the harvester 10. In the illustrated embodiment, the processor 42 is operable to receive the positional data via input 44, specifically here in the form of input signals 50 received from the positioning module 34.

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as set out herein and a machine readable storage storing such a program. Still further, embodiments of the present invention may be conveyed electronically via any medium such as a communication signal carried over a wired or wireless connection and embodiments suitably encompass the same.

It will be appreciated that the above embodiments are discussed by way of example only. Various changes and modifications can be made without departing from the scope of the present application.

1. A control system for controlling operation of one or more operational parameters of an agricultural machine, the control system comprising one or more controllers, and being configured to:
receive positional data indicative of a position of the agricultural machine within a mapped environment;
determine a heading parameter indicative of a direction of travel of the agricultural machine within the mapped environment in dependence on the positional data;
retrieve an appropriate operational profile associated with the determined heading parameter, the operational profile comprising a set of one or more operational parameters for one or more operable components of or controllable by the agricultural machine; and
generate and output one or more control signals for controlling operation of the one or more operable components in accordance with the retrieved operational profile.

2. A control system as claimed in claim 1, wherein the operational parameter(s) relate to parameter(s) utilised by the agricultural machine whilst traversing a path substantially parallel to the determined heading parameter.

3. A control system as claimed in claim 1, operable to:
retrieve a first operational profile associated with a heading parameter indicative of a first direction of travel; and
retrieve a second operational profile associated with a heading parameter indicative of a second direction of travel;
wherein the first and second directions of travel are substantially parallel but opposite to one another.

4. A control system of claim 1, configured to:
receive additional sensor data; and
update or adjust one or more operational parameters of an associated operational profile in dependence on the additional sensor data.

5. A control system of claim 1, configured to:
receive an operator adjustment of one or more operational parameters of a given operational profile; and
stored the adjusted operational parameter(s) as part of the relevant operational profile for subsequent retrieval and implementation.

6. A control system of claim 1, wherein the one or more operable components comprise components of a header operably coupled to a harvesting machine, including one or more crop gathering mechanisms.

7. A control system of claim 1, wherein the one or more operational parameters relate to one or more of:
an angle of the associated component;
an operational speed of the one or more components; and
a position or height of the associated component.

8. A control system as claimed in claim 1, operable to identify a turning action indicative of the machine being positioned at an end of a row/at a headland within the mapped environment.

9. A control system as claimed in claim 8, operable to identify the turning action in dependence on the received positional data.

10. A control system as claimed in claim 8, operable to retrieve and employ a third operational profile corresponding to one or more operational parameter(s) suitable for said turning action.

11. A control system as claimed in claim 1, operable to identify areas within the mapped environment having potentially poor harvesting or crop characteristics using map data and/or additional sensor data.

12. A control system as claimed in claim 1, operable to:
identify when the agricultural machine is at, is proximal to, is currently traversing, or is about to traverse such an area; and
retrieve and employ a fourth operational profile comprising operational parameter(s) suitable for such a region.

13. A system for controlling operation of one or more operational parameters of an agricultural machine, the system comprising:
a control system of claim 1; and
a positioning module configured to obtain positional data indicative of a position of the agricultural machine within the mapped environment.

14. An agricultural machine comprising a control system of claim 1.

15. A method for controlling operation of one or more operational parameters of an agricultural machine, the method comprising:
determining a heading parameter indicative of a direction of travel of an agricultural machine within a mapped environment in dependence on positional data indicative of a position of the agricultural machine within the environment;
retrieving or identifying an appropriate operational profile associated with the determined heading parameter, the operational profile comprising a set of one or more operational parameters for one or more operable components of or controllable by the agricultural machine; and
controlling operation of the one or more operable components in accordance with the associated operational profile.

16. An agricultural machine comprising the system of claim 13.
